(19) United States
(12) Patent Application Publication
(10) Pub. No.: US 2019/0034861 A1
(43) Pub. Date: Jan. 31, 2019

(54) SELF-SERVICE TERMINAL ENABLED FOR REAL TIME UPDATING OF INVENTORY INFORMATION

(71) Applicant: Convipay Inc., Dover, DE (US)

(72) Inventors: Anshoo Gaur, Naperville, IL (US); Aroon Ashish Khatter, Dover, DE (US)

(21) Appl. No.: 15/662,344

(22) Filed: Jul. 28, 2017

(51) Int. Cl. G06Q 10/08; G06Q 50/28

(52) U.S. Cl. CPC G06Q 10/087; G06Q 50/28

(57) ABSTRACT

The present subject matter discloses a self-service terminal enabled for real time updating of inventory information and/or planogram associated with the self-service terminal. The self-service terminal comprises a plurality of sensors and a processing unit communicatively coupled with the plurality of sensors. In one aspect, one or more first sensors, one or more second sensors and one or more third sensors of the plurality of sensors may be positioned at a storage zone, a dispense at one or more intermediate zones between the storage zone and the dispense zone respectively. The processing unit may capture sensor inputs and process the sensor inputs to update a vending data pre-stored in the memory. The processing unit may update an inventory information based upon the updated vending data and thereby generating an updated planogram. The processing unit may further transmit the updated planogram to a user device in communication with the processing unit.

### CROSS-REFERENCE TO RELATED APPLICATIONS AND PRIORITY

The present application does not claim priority from any other patent application(s).

### TECHNICAL FIELD

The present invention in general relates to a device and system of self-service terminal enabled for real time updating of inventory information.

### BACKGROUND

Vending devices are used everywhere to sell different products 24 hours a day. Vending devices contains racks or shelfs to store products, food items, beverages which are dispensed to customers or users. If user wants any product from the vending device, the product is transferred from the storage area to the dispensing area. Typically, the inventory information is updated by a vending device operator after every predefined interval. However, such manual updating of the inventory information is cumbersome and, more importantly, prone to errors. Further, the vending machine operator is unable to analyse the dispense history in order to suitably refill the products in the vending device. For example, the vending machine operator may not be able to keep track of number of products vend successfully, number of products failed from getting dispensed, a product that was vended for maximum number of times, a product that was ordered for minimal number of times, and the like.

Many a times, the product ordered to vend may be dispensed from the storage area but failed to reach the dispensing area from where the consumer can take the product. This may be due to failure of a component in the vending device due to some technical glitch. Such technical failure may result in incorrect updating of the inventory information. For example, the inventory information may indicate a product being dispensed which got stuck in an intermediate area connecting the storage area and the dispensing area. Further, since the reason for the failure of the vending device is not traceable easily, the process of refund to a consumer is not initiate instantaneously and the consumer need to wait for unreasonable time to get the refund. Therefore, there is long standing need for improved device, system and/or method that facilitates real time updating of inventory information which is intuitive, user-friendly and error-free.

### SUMMARY

Before the present device, system and its method of use is described, it is to be understood that this disclosure is not limited to the particular apparatus and its arrangement as described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is not intended to identify essential features of the subject matter nor it is intended for use in detecting or limiting the scope of the proposed subject matter.

In one implementation, a self-service terminal enabled for real time updating of inventory information and/or planogram associated with the self-service terminal is disclosed. The self-service terminal may comprise a plurality of sensors. In one aspect, one or more first sensors of the plurality of sensors may be positioned at a storage zone within the self-service terminal. Further, one or more second sensors of the plurality of sensors may be positioned at a dispense zone within the self-service terminal. The self-service terminal may further comprise a processing unit communicatively coupled with the plurality of sensors. The processing unit may further comprise a processor and a memory coupled with the processor. The processor may be configured to execute programmed instructions stored in the memory. In one aspect, the processor may execute a programmed instruction for capturing sensor inputs from at least one first sensor and at least one second sensor. Further, the processor may execute a programmed instruction for processing the sensor inputs captured from the at least one first sensor and the at least one second sensor in order to update a vending data pre-stored in the memory. In one aspect, the vending data may be updated with number of products available for dispense in the self-service terminal, number of products dispensed successfully from the self-service terminal and number of products failed to dispense from the self-service terminal. The processor may further execute a programmed instruction for updating inventory information associated with the self-service terminal based upon the updated vending data and generating an updated planogram thereof. Furthermore, the processor may execute a programmed instruction for transmitting the planogram to a user device in communication with the processing unit.

In another implementation, a method enabling a self-service terminal to real time update inventory information and/or planogram associated with the self-service terminal is disclosed. The method may comprise positioning a plurality of sensors within the self-service terminal. In one aspect, one or more first sensors of the plurality of sensors may be positioned at a storage zone within the self-service terminal. Further, one or more second sensors of the plurality of sensors may be positioned at a dispense zone within the self-service terminal. The method may further comprise capturing, by a processing unit, sensor inputs from at least one first sensor and at least one second sensor. Further, the method may comprise processing, by the processing unit, the sensor inputs captured from the at least one first sensor and the at least one second sensor in order to update a vending data pre-stored in the memory. In one aspect, the vending data may be updated with number of products available for dispense in the self-service terminal, number of products dispensed successfully from the self-service terminal and number of products failed to dispense from the self-service terminal. Further, the method may comprise updating, by the processing unit, inventory information associated with the self-service terminal based upon the updated vending data and generating an updated planogram thereof. Furthermore, the method may comprise transmitting, by the processing unit, the planogram to a user device in communication with the processing unit.

In yet another embodiment, a non-transitory computer readable medium storing a program for real time updating of inventory information and/or planogram associated with a self-service terminal is disclosed. The program may comprise a plurality of programmed instructions. The plurality of programmed instructions may comprise instructions for capturing sensor inputs from at least one first sensor and at least one second sensor. Further, the plurality of programmed instructions may comprise instructions for processing the sensor inputs captured from the at least one first sensor and the at least one second sensor in order to update a vending data pre-stored in the memory, wherein the vending data is updated with number of products available for dispense in the self-service terminal, number of products dispensed successfully from the self-service terminal and number of products failed to dispense from the self-service terminal. The plurality of programmed instructions may further comprise instructions for updating inventory information associated with the self-service terminal based upon the updated vending data and generating an updated planogram thereof. Furthermore, the plurality of programmed instructions may comprise instructions for transmitting the planogram to a user device in communication with the processing unit.

### BRIEF DESCRIPTION OF DRAWINGS

The detailed description is described with reference to the accompanying Figures. In the Figures, the left-most digit(s) of a reference number identifies the Figure in which the reference number first appears. The same numbers are used throughout the drawings to refer like features and components.

FIG. 1 illustrates an implementation system 101 in a self-service terminal for real time updating of the inventory and/or planogram associated with the self-service terminal, in accordance with an embodiment of the present subject matter.

FIG. 2 illustrates a block diagram 200 depicting components of a processing unit 105 within the self-service terminal, in accordance with an embodiment of the present subject matter.

FIG. 3 illustrates a system 101 and components of the system, in accordance with the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that, the singular forms “a,” “an,” and “the” include plural references unless the context clearly dictates otherwise. Although any methods similar or equivalent to those described herein can be used in the practice or testing of embodiments of the present disclosure, the exemplary methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

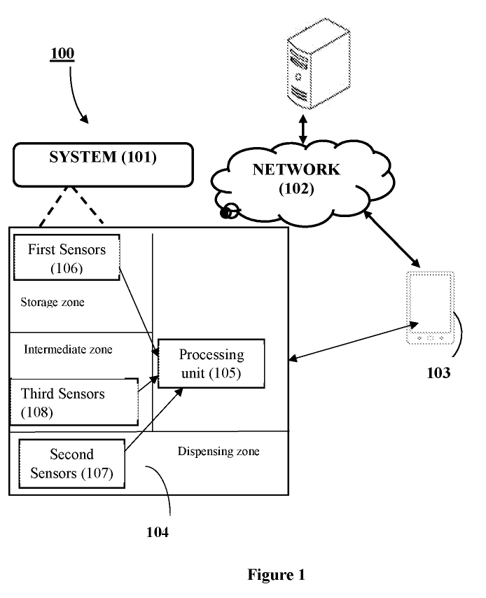

Referring to FIG. 1, implementation 100 of a system 101 in a self-service terminal 104 for real time updating of the inventory and/or planogram associated with a self-service terminal is illustrated, in accordance with an embodiment of the present subject matter. As shown in FIG. 1, the self-service terminal 104 may comprise a processing unit 105 and a plurality of sensors. In one embodiment, the plurality of sensors may comprise one or more first sensors 106, one or more second sensors 107 and one or more third sensors 108. In one embodiment, the one or more first sensors 106 may be positioned at a storage zone within the self-service terminal. In one embodiment, the one or more second sensors 107 may be positioned at dispense zone within the self-service terminal. In one embodiment, the one or more third sensors 108 may be positioned at one or more intermediate zones between the storage zone and the dispense zone. In one embodiment, the storage zone may indicate a region/area, within the self-service terminal, comprising various racks and shelves adapted to accommodate the plurality of products. In one embodiment, the one or more first sensors 106 may be arranged as a sensor mat or a sensor grid in the storage zone of the self-service terminal. In another embodiment, the one or more first sensors 106 may be placed individually to detect presence and absence of each product in the racks/shelfs. In one embodiment, the one or more second sensors 107 may be arranged in the dispensing zone. In one embodiment, the dispense zone may indicate the region/area, within the self-service terminal 104, where at least one product is dispensed through the self-service terminal 104. In one embodiment, the one or more second sensors 107 may be configured to detect presence or absence of the products in the dispensing zone. In one embodiment one or more intermediate zones indicates a region/area arranged in between the storage zone and dispense zone in order to transfer the one or more products stored in storage zone in to the dispensing zone. In one embodiment, the one or more intermediate zones may comprise one or more third sensors 108. In one embodiment, the one or more third sensors may be configured to detect presence or absence of one or more products in the one or more intermediate zones.

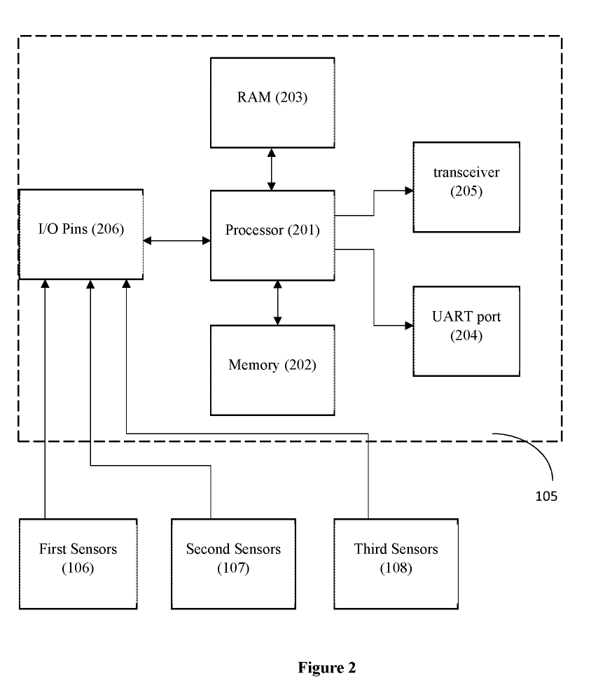

Now referring to FIG. 2, components of the processing unit 105 within the self-service terminal in accordance with an embodiment of the present subject matter is illustrated. In one embodiment, the processing unit 105 comprises a processor 201, a memory 202 a Random-Access Memory (RAM) 203, a transceiver 205, an I/O pins 206, and a UART port 204. The memory 202 may be coupled with the processor 201 wherein the processor 201 may be configured to execute programmed instructions stored in the memory. In one embodiment, the Random-Access Memory (RAM) 203, the transceiver 205, the I/O pins 206 and the UART port 204 may be electronically coupled with the processor 201. In one embodiment, the one or more first sensors 106, one or second sensors 107 and one or more third sensors 108 may be electronically coupled with the processor via the I/O pins 206.

In one embodiment, the UART port 204 may provide communication port/interface for connecting another processor/controller unit. In one embodiment, the processing unit 105 may be retrofitted in the self-service terminal using UART port 204. In one exemplary embodiment, the processing unit 105 may be retrofitted with the vending device through the communication port/interface. In one embodiment, the transceiver 205 may be configured to provide communication network between the processing unit 105 and the user device 103. In another embodiment, the processing unit 105 comprises a transceiver. The transceiver may be configured to communicate with the user device 103 using a short-range communication protocol. In one embodiment, the processing unit 105 may be communicatively coupled with the processor using a wireless communication protocol such as a short-range communication protocol selected from a group comprising, Bluetooth communication protocol, Near Field Communication (NFC), Radio Frequency (RF) protocol, an infra-red (IR) protocol, ZigBee protocol. In one embodiment, the processor 105 may be communicatively coupled with a router (Not shown in the figure) in order to communicate with the user device 103.

Now referring to FIG. 1, the processing unit 105 may be communicatively coupled with a user device 103. In one embodiment, the processing unit 105 may be electronically coupled with a display and a keypad (Not shown in the figure). In one embodiment, the processing unit 105 may communicate with the user device 103 through a wireless communication protocol selected from a group comprising, but not limited to, Bluetooth communication protocol, Near Field Communication (NFC), Radio Frequency (RF) protocol, an infra-red (IR) protocol, ZigBee protocol and the like. Further, the user device 103 may be communicatively coupled with system 101 implemented in the self-service terminal.

Further, the user device 103 may be communicatively coupled with a server. It may be understood that the server may also be implemented in a variety of computing systems, such as a laptop computer, a desktop computer, a notebook, a workstation, a mainframe computer, a server, a network server, and the like. It will be understood that the data stored on the server may be accessed by multiple users through one or more user devices 103-1, 103-2 . . . 103-N, collectively referred to as user 103 hereinafter, or applications residing on the user devices 103. Examples of the user devices 103 may include, but are not limited to, a portable computer, a personal digital assistant, a handheld device, and a workstation. The user devices 103 are communicatively coupled to the server through a network 102.

In one implementation, the network 102 may be a wireless network, a wired network or a combination thereof. The network 102 can be accessed by the user device 104 using wired or wireless network connectivity means including updated communications technology. The network 102 can be implemented as one of the different types of networks, such as intranet, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 102 may include a variety of network devices, including routers, bridges, servers, computing devices, storage devices, and the like.

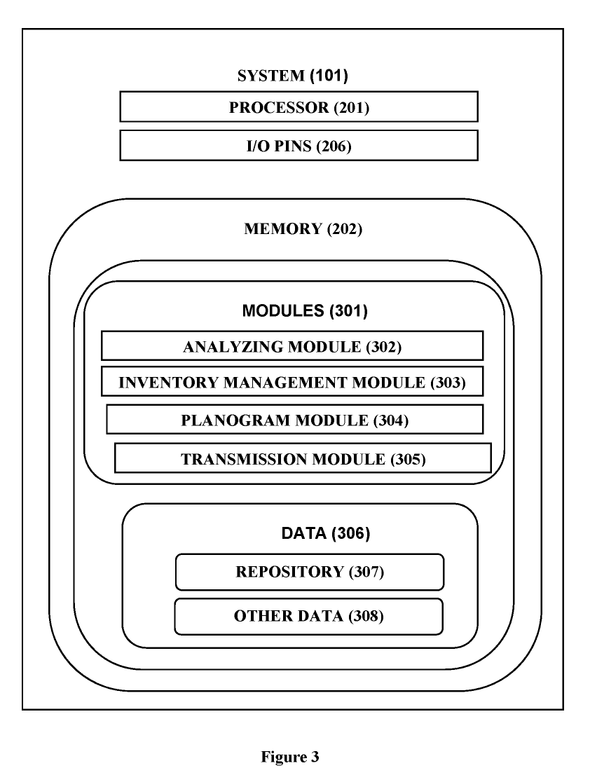

Now referring to FIG. 3, components of the system 101 are illustrated in accordance with an embodiment of the present subject matter. The system 101 may implemented on the processing unit 105. The processing unit 105 may comprise a processor 201, I/O pins 206, a memory 202, modules 301 and data 205. In one embodiment, the processor 201 is configured to fetch and execute computer-readable instructions stored in the memory 202.

In one embodiment, the I/O pins 206 may be electronically coupled with the one or more first sensors 106, the one or more second sensors 107 and the one or more third sensors 108. The processor 201 may be configured to capture sensor inputs from at least one first sensor, at least one second sensor and at least one third sensor. In one exemplary embodiment, the one or more first sensors may be a volume sensor, a weight sensor, etc. In one exemplary embodiment, the one or more second sensors may be an optical vend sensor, an infrared (IR) sensor etc. In one exemplary embodiment, the one or more third sensors may be an IR sensor and an optical sensor, etc.

In an implementation, the memory 202 may include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and memory cards. The memory 202 may include modules 301 and data 306.

The modules include routines, programs, objects, components, data structures, etc., which perform particular tasks, functions or implement particular abstract data types. In one implementation, the modules may include an analysing module 302, an inventory management module 303, a planogram module 304, a transmission module 305 and other modules (not shown in figure).

In one embodiment, the data 306 may comprise repository 307 and other data 308. In one exemplary embodiment, the repository 307 may be configured to store data processed, received, and generated by one or more of the modules 301. In one exemplary embodiment, the repository 307 may store vending data available in vending devices. The other data 308 may include data generated as a result of the execution of one or more modules.

In one implementation, the user device 103 may be communicatively coupled with the processing unit 105 of the self-service terminal using short range communication protocol. The user may use an application installed on the user device 103 in order to receive the updated data from the system 101.

In one embodiment, the analysing module 302 may be configured to process the sensor inputs captured from the at least one first sensor, the at least one second sensor and the at least one third sensor in order to update a vending data pre-stored in the memory 202. In one exemplary embodiment, one or more first sensors, one or more second sensors and one or more third sensors may transmit input based on the presence or absence of the product in the storage zone, the dispensing zone and the intermediate zone to the processor 105. The analysing module 302 may process the sensor input data and analyse the products available for dispense in the self-service terminal, number of products dispensed successfully from the self-service terminal and number of products failed to dispense from the self-service terminal. Further, the analysing module 302 may track the vending data stored in the log file and if it is determined that there is continuous failure of a particular product through a particular tray or a rack, the system 101 may send an alert to the operator to check and diagnose the components dispensing the particular product or change/replace the product itself on the said tray/rack.

In one embodiment, the inventory management module 303 may be configured to update inventory information based on the updated vending data. The updated vending data comprises number of products available for dispense in the self-service terminal, number of products dispensed successfully from the self-service terminal and number of products failed to dispense from the self-service terminal.

In one embodiment, the planogram module 304 may be configured to generate planogram based on the updated inventory information. In one embodiment, the planogram of the vending device may indicate a virtual image of number and arrangement of the all products in the shelves, racks or trays. In one embodiment, the planogram may be used by the operator to refill the self-service terminal.

In one embodiment, the transmission module 305 may be configured to transmit the updated planogram to a user device 103. In one embodiment, the user device 103 may be in communication with the processing unit 105 via a communication protocol. In one embodiment, the transmission module 305 may transmit the updated planogram to the user device 103 using a short-range communication protocol selected from a group comprising, Bluetooth communication protocol, Near Field Communication (NFC), Radio Frequency (RF) protocol, an infra-red (IR) protocol, ZigBee protocol. In one embodiment, the transmission module 305 may transmit updated planogram to the user device via a router placed in the self-service terminal. Further, the user device may transmit the updated planogram to the server which is accessible by other user devices intending to communicate with the vending device for conducting future vending transaction based upon the updated inventory information and/or updated planogram.

In one exemplary embodiment, a user may approach a self-servicing terminal (e.g. a vending device) to order a product for dispensing through the vending device. After performing a cash/cashless transaction, the vending device may dispense the product placed in the particular rack or shelf in the storage zone. One or more first sensors placed in the storage zone may detect absence or presence of the product from the rack. Then, one or more third sensors placed in the one or more intermediate zone, connecting the storage zone and the dispensing zone, may detect the product while passing through the intermediate zone. Further, one or more second sensors placed in the dispensing zone may detect final exit of the product from the dispensing zone. It is to be noted that the analysis of all the inputs of the sensors may be utilized to determine successful dispensing of product from the vending device as well as failure in dispensing of the product from the vending device. The processing unit 105 may update the vending data as per the analysis and update the inventory information. This inventory information is configured to generate planogram which may further be sent to the user device in order to update inventory stored on the server. In one embodiment, the user device may generate a request message to initiate refund for dispense failure from the self-service terminal. In one embodiment, the refund request message is further transmitted to the payment server for a failed dispense.

Although implementations for real time updating of inventory information and/or planogram associated with the self-service terminal have been described in language specific to structural features and/or methods, it is to be understood that the appended claims are not necessarily limited to the specific features or methods described. Rather, the specific features and methods are disclosed as examples of implementations for real time updating of inventory information and/or planogram associated with the self-service terminal.

What is claimed is:

1. A self-service terminal enabled for real time updating of inventory information and/or planogram associated with the self-service terminal, comprising:
a plurality of sensors, wherein one or more first sensors of the plurality of sensors are positioned at a storage zone within the self-service terminal, and wherein one or more second sensors of the plurality of sensors are positioned at a dispense zone within the self-service terminal; and
a processing unit communicatively coupled with the plurality of sensors, wherein the processing unit further comprises
a processor; and
a memory coupled with the processor wherein the processor is configured to execute programmed instructions stored in the memory for
capturing sensor inputs from at least one first sensor and at least one second sensor;
processing the sensor inputs captured from the at least one first sensor and the at least one second sensor in order to update a vending data pre-stored in the memory, wherein the vending data is updated with number of products available for dispense in the self-service terminal, number of products dispensed successfully from the self-service terminal and number of products failed to dispense from the self-service terminal;
updating inventory information associated with the self-service terminal based upon the updated vending data and generating an updated planogram thereof; and
transmitting the planogram to a user device in communication with the processing unit.

2. The self-service terminal of claim 1, wherein the processor unit is retrofitted with vending device.

3. The self-service terminal of claim 1, wherein the storage zone indicates a region/area, within the self-service terminal, comprising various racks and shelves adapted to accommodate the plurality of products.

4. The self-service terminal of claim 1, wherein the dispense zone indicates a region/area, within the self-service terminal, wherein at least one product is dispensed through the self-service terminal.

5. The self-service terminal of claim 1, wherein the plurality of sensors further comprises one or more third sensors positioned at one or more intermediate zones between the storage zone and the dispense zone.

6. The self-service terminal of claim 5, wherein one or more intermediate zones indicates a region/area, within the self-service terminal, in between the storage zone and dispense zone.

7. The self-service terminal of claim 6, wherein the vending data pre-stored in the memory is updated using the at least one third sensor along with the at least one first sensor and the at least one second sensor.

8. The self-service terminal of claim 1, wherein the processing unit communicates with the user device using a router or a short-range communication protocol selected from a group comprising, Bluetooth communication protocol, Near Field Communication (NFC), Radio Frequency (RF) protocol, an infra-red (IR) protocol, ZigBee protocol.

9. The self-service terminal of claim 6, wherein the self-service terminal IS configured to transmit the planogram to the user device in order to generate a request message to initiate refund for dispense failure from the self-service terminal wherein the request message is further transmitted to the payment server.

10. The self-service terminal of claim 1, wherein the one or more first sensors are in form of a sensor mat or a sensor grid, and wherein each of the first sensors, the second sensors and the third sensors may include one or more of proximity sensors, IR sensors, weight sensors.

11. The self-service terminal of claim 1, wherein the user device is further configured to transmit the updated inventory and/or the updated planogram to a computing system communicatively coupled with the user device and being accessible by one or more other user devices.

12. A method enabling a self-service terminal to real time update inventory information and/or planogram associated with the self-service terminal, the method comprising:
positioning a plurality of sensors within a self-service terminal, wherein one or more first sensors of the plurality of sensors are positioned at a storage zone within the self-service terminal, and wherein one or more second sensors of the plurality of sensors are positioned at a dispense zone within the self-service terminal;
capturing, by a processing unit, sensor inputs from at least one first sensor and at least one second sensor;
processing, by the processing unit, the sensor inputs captured from the at least one first sensor and the at least one second sensor in order to update a vending data pre-stored in the memory, wherein the vending data is updated with number of products available for dispense in the self-service terminal, number of products dispensed successfully from the self-service terminal and number of products failed to dispense from the self-service terminal;
updating, via the processing unit, inventory information associated with the self-service terminal based upon the updated vending data and generating an updated planogram thereof; and
transmitting, by the processing unit, the planogram to a user device in communication with the processing unit.

13. The method of claim 12 further comprising one or more third sensors of the plurality of sensors positioned within one or more intermediate zones between the storage zone and the dispensing zone.

14. The method of claim 13 further comprising updating the vending data pre-stored in the memory using at least one third sensor along with the at least one first sensor and the at least one second sensor.

15. The method of claim 12 further comprising enabling the user device to transmit the updated inventory and/or the updated planogram to a computing system communicatively coupled with the user device and being accessible by one or more other user devices.

16. A non-transitory computer readable medium storing a program for real time updating of inventory information and/or planogram associated with a self-service terminal, the program comprising programmed instructions, the programmed instructions comprising instructions for:
capturing sensor inputs from at least one first sensor and at least one second sensor;
processing the sensor inputs captured from the at least one first sensor and the at least one second sensor in order to update a vending data pre-stored in the memory, wherein the vending data is updated with number of products available for dispense in the self-service terminal, number of products dispensed successfully from the self-service terminal and number of products failed to dispense from the self-service terminal;
updating inventory information associated with the self-service terminal based upon the updated vending data and generating an updated planogram thereof; and
transmitting the planogram to a user device in communication with the processing unit.
